(19) United States
(12) Patent Application Publication
(10) Pub. No.: US 2013/0342631 A1
(43) Pub. Date: Dec. 26, 2013

(54) Multi-User Videophone Hub

(71) Applicants: Alejandro Garfio, West Covina, CA (US); Michel Alvarez, Miami Beach, FL (US); Gary Elsasser, Coto de Caza, CA (US)

(72) Inventors: Alejandro Garfio, West Covina, CA (US); Michel Alvarez, Miami Beach, FL (US); Gary Elsasser, Coto de Caza, CA (US)

(73) Assignee: Fugoo Corporation, Irvine, CA (US)

(21) Appl. No.: 13/528,985

(22) Filed: Jun. 21, 2012

(51) Int. Cl. H04N 7/14

(52) U.S. Cl. 348/14.01; 348/E07.077

(57) ABSTRACT

A multi-user videophone hub may include a processor, a video camera, a display, and a wireless communication interface to communicate with at least one local handset. The processor may be configured to receive video from the at least one local handset, and create a composite video stream based on video from the video camera and the video received from the at least one local handset. The processor may also be configured to send the composite video stream to a remote device and receive video from the remote device. The processor may then show the video from the remote device on the display, and send the video from the remote device to the at least one local handset.

### BACKGROUND

1. Technical Field

The present subject matter relates to audio and video communication, and more particularly, to a hub supporting audio and/or video communication with both a remote device and local handsets.

2. Description of Related Art

Communication using audio and video using a phone-like device has been discussed in the art for decades with practical systems emerging over the last few years. The devices used for the audio-video (AV) communication may be referred to as videophones. Early videophones often used a standard analog telephone line which may be referred to as plain old telephone service (POTS). Some videophones used other communication interfaces such as integrated services digital network (ISDN) lines or other telephony interfaces. More recently, many videophones have used internet protocol (IP) to communicate over the internet.

Computers and smart phones are commonly used for AV communication. Videophone applications such as Skype™ software from Microsoft Inc., or Facetime® software from Apple Inc. allow general purpose computing devices to act as a videophone or video conferencing device Such software applications commonly communicate directly with another device over the internet. In some cases, videophone applications or dedicated videophone hardware may connect through a hub that is accessible over the internet, instead of communicating directly with each other. Some hubs may also provide for multi-user AV communication to allow three or more people to participate in a common videophone call.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. They should not, however, be taken to limit the invention to the specific embodiment(s) described, but are for explanation and understanding only. In the drawings:

FIG. 1 is a block diagram of a multi-user videophone hub;

FIG. 2 shows a multi-user videophone system; and

FIG. 3 is a flow chart of a method to communicate using audio and video.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures and components have been described at a relatively high-level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification. Reference now is made in detail to the examples illustrated in the accompanying drawings and discussed below.

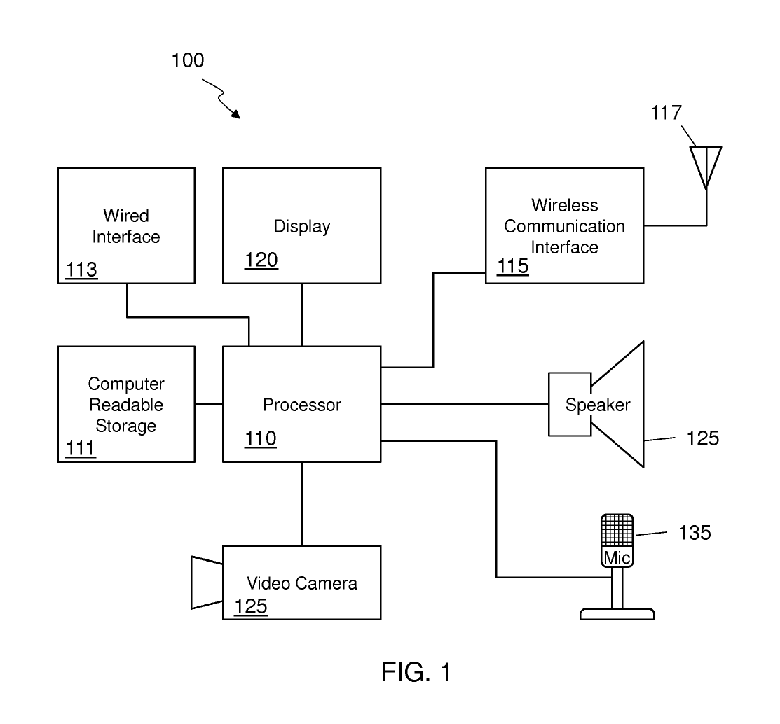

FIG. 1 is a block diagram of a multi-user videophone hub 100. The videophone hub 100 may include a processor 110 to execute program code that may be stored in computer readable storage 111, The computer readable storage 111 may be an optical disc, a hard drive, flash memory, dynamic random access memory (DRAM), read-only memory (ROM), or any other type of computer readable storage. Some embodiments may include more than one processor 110 and/or may use a special purpose processor for one or more tasks, such as video compression, video expansion, audio compression, audio expansion, video compositing, audio mixing, network protocol processing, or other tasks.

A wireless communication interface 115 that may communicate through the antenna 117 using one or more radio frequencies may also be coupled to the processor. The wireless communication interface 115 may be suitable for communication with local devices. In one embodiment, the wireless communication interface 115 may be capable of communicating, under most conditions, with local devices that are no further away than one mile. In another embodiment, the wireless communication interface may be limited to communication with local devices in the same building or even the same room, using a wireless local network. In some embodiments, the wireless communication interface may be compatible with a standard published by the Institute of Electrical and Electronics Engineers (IEEE), such as a version of the IEEE 802.11 standard.

In some embodiments, a wired interface 113 may be included and coupled to the processor 110. The wired interface 113 may be an interface to an analog phone line, an ethernet interface, an ISDN interface, or any other type of wired interface. The wired interface 113 may be useful to communicate with a remote device, such as a videophone or a computer running video communication software. In some embodiments, the processor 110 may communicate to a remote device over the wireless communication interface 115 through a router, gateway, or some other device that couples the wireless local network to a wide area network, public switched telephone network, or other public network or long distance communication link.

The videophone hub 100 may also include a display 120 and a speaker 125 coupled to the processor 110. The processor 110 may render video that is received from the remote device and show the rendered video on the display 120. In some embodiments, the rendered video may be provided to an external monitor acting as the display 120, through a video connector. The processor 110 may render audio that is received from the remote device and play the audio through the speaker 125. In some embodiments, the speaker 125 may be included in a handset, and some embodiments may support alternative speakers such as a plug-in headset, a Bluetooth headset, or an audio output connector that may be used to drive an external speaker.

The videophone hub 100 may include a video camera 125 and a microphone 135. The video camera 125 may be mounted in a fixed position on the videophone hub 100 in some embodiments, but other embodiments may provide for aiming the video camera 125 using a pivot, swivel, flexible arm, a cable to an external camera, or some other mechanism. The video camera 125 is coupled to the processor 110 and the processor 110 may perform video processing on the video from the video camera 125. The microphone 135 is coupled to the processor 110 and the processor 110 may perform audio processing on the audio from the microphone 135. In some embodiments, the microphone may be included in a handset, and some embodiments may support alternative microphones such as a plug-in headset, a Bluetooth headset, or an audio input connector that may be coupled to an external microphone.

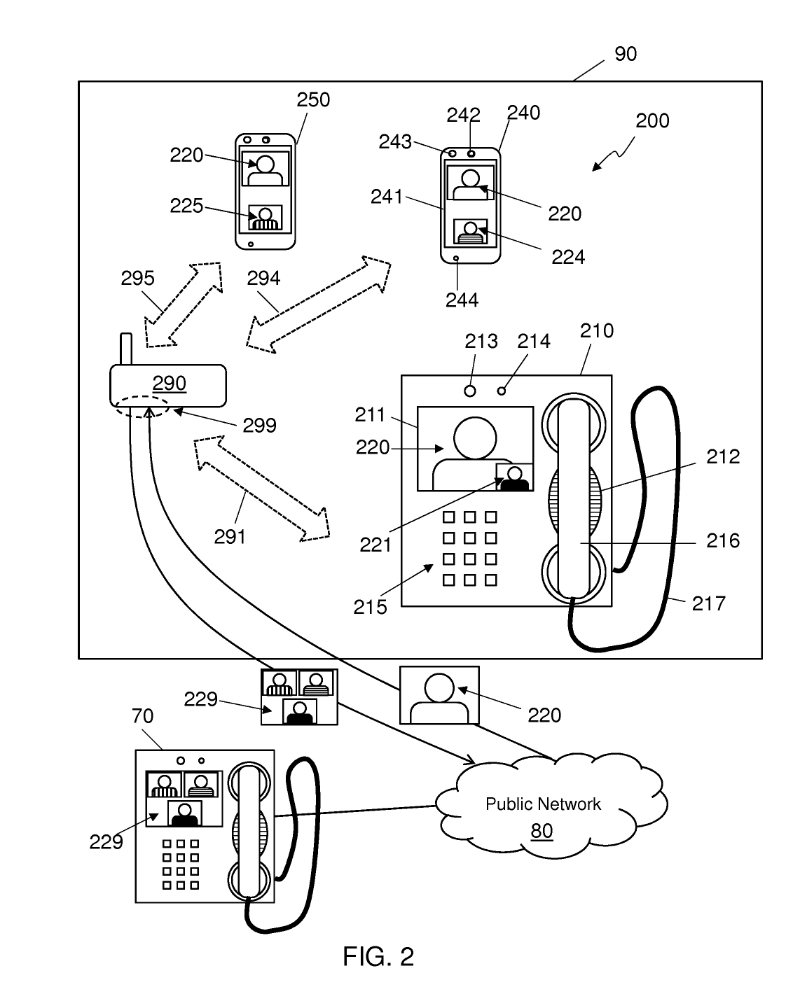

FIG. 2 shows a multi-user videophone system 200. A videophone hub 210 may be similar to the videophone hub 100 of FIG. 1, and may include a processor, a hub display 211, a hub speaker 212, a hub video camera 213 and a hub microphone 214. Some embodiments may include a keypad 215 and/or a handset 216 that may be coupled to the videophone hub 210 by a cord 217. The handset 216 may include an alternative hub microphone and alternative hub speaker that may be used in place of the hub microphone 214 and hub speaker 212 if the handset 216 is picked up. The videophone hub 210 may include a wireless communication interface that communicates using radio waves 291 to a wireless network access point 290. In some embodiments, the access point 290 may include an interface 299 to the internet or other public network 80 and may provide a path for the videophone hub 210 to communicate with a remote device, such as the remote videophone 70. In other embodiments, the videophone hub 210 may include a wired interface to provide a communication path to a public network or other path to a remote device. The videophone hub 210 may include a case to mechanically couple the processor, the wireless communication interface, the hub video camera 213, the hub microphone 214, the hub speaker 213, and the hub display 211.

A first local handset 240 and a second local handset 250 may be included in the multi-user videophone system 200. Any number of local handsets may be included, with other embodiments including a single local handset 240 and additional embodiments including more than two local handsets. The local handsets 240, 250 may communicate with the videophone hub 210 wirelessly. In the embodiment shown, the first local handset 240 may communicate to the videophone hub 210 through the access point 290 using radio waves 294. In other embodiments the local handset(s) 240, 250 may communicate directly to the videophone hub 210 without using an intermediate access point 290. The first local handset 240 may include a handset display 241, a handset speaker 242, a handset camera 243 and a handset microphone 244.

The first local handset 240 may be, in some embodiments, a dedicated device to be a local handset for the videophone hub 210. The dedicated device may include a combination of hardware, firmware and software for implementing the functions of the local handset. In some embodiments, the local handset 240 may be a general purpose mobile computing device, such as an iPod Touch® from Apple, Inc. or a tablet, running a program to enable the communication with the videophone hub 210. In other embodiments, the first local handset 240 may be a smartphone, such as an iPhone® smartphone from Apple, Inc. or a mobile phone running the Android™ operating system from Google. The smartphone may be able to connect directly to a wide area network such as a cellular telephony network, but a local wireless network, such as a Wi-Fi® network compliant with a version of the IEEE 802.11 standard is used to communicate to the videophone hub 210. The smartphone may be running an app, or some other type of software or firmware program, to provide the capability to communicate with the videophone hub 210.

The second local handset 250 may communicate to the videophone hub 210 through the access point 290 using radio waves 295. In the embodiment shown, the local video handsets 240, 250 and the videophone hub 210 are located in a single building 90. The wireless communication interfaces of the local handsets 240, 250 and the videophone hub 210 may be limited to communication over a short distance under most circumstances, such as less than about one mile in some embodiments, and less than about 1000 feet in other embodiments. Some embodiments may be limited to even shorter ranges for the wireless communication.

The videophone hub 210 may communicate with a remote device, such as a computer, tablet or smartphone running videoconferencing software, or a remote videophone 70. The communication may take place over a public network 80, which may be the public switched telephone network (PSTN), the internet, or any other long distance communication network. The remote videophone 70 may be located anywhere, but communicates with the videophone hub 210 over a communication path that includes components other than the wireless local network supported by the access point 290, even though the communication path between the videophone hub 210 and the remote videophone 70 may include the wireless local network in some embodiments.

The remote videophone 70 may send remote audio and/or remote video 220 to the videophone hub 210. The communication between the remote videophone 70 and the videophone hub 210 may comply with any proprietary or standards based protocol. In some embodiments, the communication may be performed using protocols that are compliant with the International Telecommunications Union (ITU) H.320 standard, the ITU H.264 standard, or the ITU V.80 standard. The videophone hub 210 may receive the remote audio and/or remote video 220 from the remote device, show the remote video 220 on the hub display 211, and play the remote audio on the hub speaker 212. The videophone hub 210 may also send the remote audio and/or the remote video 220 to the first local handset 240 and, in some embodiments, to the second local handset 250. The first local handset 240 may receive the remote audio and/or remote video 220 and render the remote audio to the handset speaker 242 and/or render the remote video 220 to the handset display 241. The second local handset 250 may also receive and render the remote audio and/or remote video 220.

The first handset 240 may capture handset video 224 using the handset camera 243 and/or handset audio using the handset microphone 244. In some embodiments, the first handset 240 may show the handset video 224 on the handset display 241 in addition to the remote video 220. The first handset 240 may send the handset audio and/or handset video 224 to the videophone hub 210 over the wireless local network using radio waves 294, the access point 290 and radio waves 291. The second handset 250 may also capture video 225 and send it to the video phone hub 210. The handsets 240, 250 may use any type of protocol to communicate with the videophone hub 210 but in some embodiments, the protocol used between the handsets 240, 250 and the videophone hub 210 may be different than the protocol used between the videophone hub 210 and the remote videophone 70.

The videophone hub 210 may capture hub audio using the hub microphone 214 and hub video 221 using the hub video camera 213. The videophone hub 210 may show the hub video 221 on the hub display in addition to the remote video 220. The videophone hub 210 may receive audio and/or video 224 from the first handset 240, and in some embodiments, audio and/or video 225 from the second handset 240. The videophone hub 210 may then create a composite video stream 229 based on the hub video 221, the handset video 224, and in some embodiments, the video 225. The composite video stream 229 may include the multiple videos 221, 224, 225 composited in any way, including, but not limited to, providing separate windows of equal size to the various videos, providing the hub video 221 in a larger window with smaller windows for handset videos 224, 225, providing the multiple videos 221, 224, 225 in overlapping windows with or without transparency, providing separate small windows for the various videos and dynamically enlarging the window for the video that has active audio, providing a full screen version of the video with active audio with small windows of the other video overlaid on the full-screen video, or any other video stream that utilizes at least two of the video streams, spatially and/or temporally, from the videophone hub 210 and the handsets 240, 250.

The videophone hub 210 may also create a composite audio stream based on the hub audio and the audio received from the at least one local handset. The various audio streams may be simply mixed, switched temporally based on relative volume levels, or otherwise combined into a single audio stream that utilizes at least two of the audio streams from the videophone hub 210 and the handsets 240, 250. The videophone hub 210 may then send the composite audio stream and/or the composite video stream 229 to the remote videophone 70.

The remote videophone 70 may then play the composite audio stream and show the composite video stream 229 as if it is coming from a single user. The videophone hub 210 combines the AV streams from the multiple local users into a single AV stream. The remote videophone 70 receives a single audio/video (AV) stream and does not have any special support for communicating with multiple users. An audio stream and related video stream may be referred to as an audio/video stream or AV stream, even if the audio stream and the video stream are not multiplexed or combined into a single data structure or data connection.

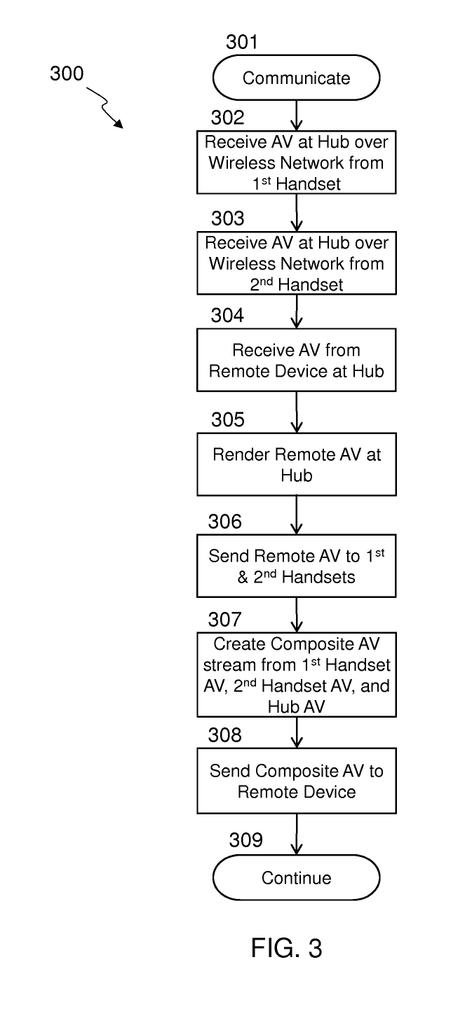

FIG. 3 is a flow chart 300 of a method to communicate using audio and video. The flow chart 300 is described as it may relate to the multi-user videophone system 200 of FIG. 2, but the method described may be used with a variety of communication systems. While the flow chart 300 describes discrete tasks in a sequential order, in many implementations the various tasks may be ongoing to handle ‘continuous’ streams of data and may be performed simultaneously in a pipelined fashion or performed in a time-sliced fashion in an order that is quite different than that described. In some embodiments, the various tasks may be performed on a single processor or multiple processors with some tasks performed in hardware and other tasks in software, depending on the embodiment.

The flow chart 300 begins at block 301 and the videophone hub 210 may receive first handset audio and first handset video 224 over a wireless local network from the first local handset 240 at block 302. At block 303, in some embodiments, videophone hub 210 may receive second handset audio and second handset video 225 over a wireless local network from the second local handset 250. The videophone hub 210 may receive remote audio and remote video 220 from the remote videophone 70 at block 304 and may render, or play, the remote audio on the hub speaker 212 and render, or show, the remote video 220 on the hub display 211 at block 305. At block 306 the videophone hub may send the remote audio and the remote video 220 to the first handset 240, and in some embodiments, to the second handset 250.

The videophone hub 210 may create a composite video stream 229 based on hub video 221 from a hub video camera 213, the first handset video 224, and in some embodiments, the second handset video 225, in block 307. Also in block 307, the videophone hub 210 may create a composite audio stream based on audio from a hub microphone 214, the first handset audio, and the second handset audio. At block 308, the videophone hub 210 may send the composite audio stream and the composite video stream 229 to the remote videophone 70. The communication with the remote videophone 70 may be performed using a different protocol than is used to communicate with the local handsets 240, 250. The flowchart terminates at block 309 but the method may continue as more audio and video are streamed in and out of the videophone hub 210.

As will be appreciated by those of ordinary skill in the art, aspects of the various embodiments may be embodied as a system, method or computer program product. Accordingly, aspects of various embodiments may take the form of an entirely hardware embodiment, an entirely software embodiment (including firmware, resident software, micro-code, or the like) or an embodiment combining software and hardware aspects that may all generally be referred to herein as a “handset,” “computer,” “server,” “circuit,” “module,” “hub,” “logic” or “system.” Furthermore, aspects of the various embodiments may take the form of a computer program product embodied in one or more computer readable medium(s) having computer readable program code stored thereon.

Any combination of one or more computer readable storage medium(s) may be utilized. A computer readable storage medium may be embodied as, for example, an electronic, magnetic, optical, electromagnetic, infrared, or semiconductor system, apparatus, or device, or other like storage devices known to those of ordinary skill in the art, or any suitable combination of computer readable storage mediums described herein. In the context of this document, a computer readable storage medium may be any tangible medium that can contain, or store a program and/or data for use by or in connection with an instruction execution system, apparatus, or device.

Aspects of various embodiments are described with reference to flowchart illustrations and/or block diagrams of methods, apparatus, systems, and computer program products according to various embodiments disclosed herein. It will be understood that various blocks of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. Computer program code for carrying out operations for aspects of various embodiments may be written in any combination of one or more programming languages, including an object oriented programming language such as Java, Smalltalk, C++, or the like, and conventional procedural programming languages, such as the “C” programming language or similar programming languages.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise. As used herein, the term “coupled” includes direct and indirect connections. Moreover, where first and second devices are coupled, intervening devices including active devices may be located there between.

Any element in a claim that does not explicitly state “means for” performing a specified function, or “step for” performing a specified function, is not to be interpreted as a “means” or “step” clause as specified in 35 U.S.C. §112, 116. In particular the use of “step of” in the claims is not intended to invoke the provision of 35 U.S.C. §112, 116.

The description of the various embodiments provided above is illustrative in nature and is not intended to limit the invention, its application, or uses. Thus, variations that do not depart from the gist of the invention are intended to be within the scope of the embodiments of the present invention. Such variations are not to be regarded as a departure from the intended scope of the present invention.

What is claimed is:

1. A communication apparatus comprising:
a processor coupled to a video camera and a display; and
a wireless communication interface, coupled to the processor, to communicate with at least one local handset;
wherein the processor is configured to:
receive video from the at least one local handset;
create a composite video stream based on video from the video camera and the video received from the at least one local handset,
send the composite video stream to a remote device;
receive video from the remote device;
show the video from the remote device on the display; and
send the video from the remote device to the at least one local handset.

2. The apparatus of claim 1, further comprising a microphone and a speaker, coupled to the processor;
wherein the processor is further configured to:
receive audio from the at least one local handset;
create a composite audio stream based on audio from the microphone and the audio received from the at least one local handset;
send the composite audio stream to the remote device;
receive audio from the remote device;
play the audio from the remote device on the speaker; and
send the audio from the remote device to the at least one local handset.

3. The apparatus of claim 2, further comprising:
a case to mechanically couple the processor, the wireless communication interface, the video camera, the microphone, the speaker and the display.

4. The apparatus of claim 1, wherein the processor communicates with the remote device using a different protocol than is used to communicate with the at least one local handset.

5. The apparatus of claim 1, further comprising:
a wired communication interface coupled to the processor to communicate with the remote device.

6. The apparatus of claim 5, wherein the wired communication interface is an interface to an analog phone line.

7. The apparatus of claim 1, wherein the video from the remote device is received through the wireless communication interface.

8. The apparatus of claim 1, wherein the wireless communication interface is compatible with a version of the IEEE 802.11 standard.

9. The apparatus of claim 8, wherein the at least one local handset is a smart phone configured to communicate using the version of the IEEE 802.11 standard.

10. The apparatus of claim 1, wherein the processor is further configured to:
receive video from a second local handset;
include the video from the second local handset in the composite video stream; and
send the video from the remote device to the second local handset.

11. A videophone system comprising:
a hub device having a hub display, a hub speaker, a hub camera, a hub microphone, and a hub radio frequency transceiver to communicate over a wireless local network; and
at least one local handset including a handset display, a handset speaker, a handset microphone, a handset camera, and a handset radio frequency transceiver to communicate with the hub device over the wireless local network;
wherein the hub device is configured to:
receive a remote audio/video (AV) stream from a remote videophone apparatus,
render the remote AV stream to the hub display and hub speaker, and
send the remote AV stream to the at least one local handset over the wireless local network;
the at least one local handset is configured to:
receive the remote AV stream from the hub device,
render the remote AV stream to the handset display and handset speaker,
create a first local AV stream using the handset camera and the handset microphone, and
send the first local AV stream to the hub device over the wireless local network;
and the hub device is further configured to:
receive the first local AV stream from the at least one local handset,
create a second local AV stream using the hub camera and the hub microphone,
composite the first and second local AV streams into a combined local AV stream, and
send the combined local AV stream to the remote videophone apparatus.

12. The system of claim 11, wherein the hub device communicates with the remote videophone apparatus using a different protocol than is used to communicate with the at least one local handset.

13. The system of claim 11, the hub device further comprising:
a wired communication interface coupled to the processor to communicate with the remote device.

14. The system of claim 11, wherein the audio and video from the remote device is received through the wireless communication interface.

15. The system of claim 11, wherein the wireless local network is compatible with a version of the IEEE 802.11 standard.

16. The system of claim 15, wherein the at least one local handset is a smart phone configured to communicate with the hub device using the version of the IEEE 802.11 standard.

17. The system of claim 11, further comprising a second local handset:
wherein the second local handset is configured to:
create a third local AV stream, and
send the third local AV stream to the hub device over the wireless local network;
and the hub device is further configured to:
receive the third local AV stream from the second local handset, and
composite the third local AV stream into the combined local AV stream.

18. A method to communicate comprising:
receiving audio and video over a wireless local network at a hub device from at least one local handset;
creating a composite video stream based on video from a hub video camera and the video received from the at least one local handset;
creating a composite audio stream based on audio from a hub microphone and the audio received from the at least one local handset;
sending the composite audio stream and the composite video stream to a remote device;
receiving audio and video from the remote device;
showing the video from the remote device on a hub display;
playing the audio from the remote device on a hub speaker; and
sending the audio and the video from the remote device to the at least one local handset.

19. The method of claim 18, wherein communication with the remote device is performed using a different protocol than is used to communicate with the at least one local handset.

20. The method of claim 18, wherein the audio and video from the remote device is received over the wireless local network.

21. The method of claim 18, further comprising:
receiving audio and video over the wireless local network at the hub device from a second local handset;
including the audio from the second local handset in the composite audio stream; and
including the video from the second local handset in the composite video stream; and
sending the audio and the video from the remote device to the second local handset.

22. A computer readable storage medium comprising computer executable instructions for performing the method according to claim 18.
